(19) United States
(12) Patent Application Publication
(10) Pub. No.: US 2021/0176086 A1
(43) Pub. Date: Jun. 10, 2021

(54) NOTIFICATION CONTROL DEVICE, NOTIFICATION CONTROL SYSTEM, AND NOTIFICATION CONTROL METHOD

(71) Applicant: SHARP KABUSHIKI KAISHA, Osaka (JP)

(72) Inventor: KOICHI IZU, Sakai City (JP)

(21) Appl. No.: 17/113,616

(22) Filed: Dec. 7, 2020

(30) Foreign Application Priority Data
Dec. 9, 2019 (JP) 2019-222236

(51) Int. Cl. H04L 12/28; H04W 68/12

(52) U.S. Cl. CPC H04L 12/2825; H04L 2012/285; H04W 68/12; H04L 12/282

(57) ABSTRACT

A notification control system includes a controller configured to determine a notification execution device for executing a notification, and a storage unit configured to store electronic devices capable of executing the notification. The controller includes a notification data acquisition unit configured to acquire notification data related to the notification. When the notification data acquisition unit has acquired notification data, the controller determines a notification execution device from among the electronic devices stored in the storage unit based on a prescribed condition, and causes the determined notification execution device to execute the notification based on the notification data.

### CROSS-REFERENCE TO RELATED APPLICATIONS

This application claims the benefit of priority to Japanese Patent Application Number 2019-222236 filed on Dec. 9, 2019. The entire contents of the above-identified application are hereby incorporated by reference.

### BACKGROUND

### Technical Field

The disclosure relates to a notification control device, a notification control system, and a notification control method.

In recent years, installing wireless LAN devices in the home has improved domestic communication environment, and domestic electronic devices capable of connecting to the Internet at any time, which are commonly referred to as Internet of Things (IoT) home appliances or smart home appliances, have become ubiquitous in households.

Domestic electronic devices provide users with information useful for the user in a timely manner, by being connected to the Internet. In a case where there are a plurality of domestic electronic devices connected to the Internet in a household, these domestic electronic devices work in concert with one another via a cloud server or the like provided on the Internet to configure a home network (see JP 2008-546981 T and the like).

### SUMMARY

Among the electronic devices used at home, some everyday-life home appliances such as a washing machine, kitchen home appliances such as an oven cooking range, and the like notify persons near the electronic devices of information related to completion of domestic tasks such as washing and cooking, or operation statuses or the like of the electronic devices (hereinafter, referred to as “notification information”) by using an alarm sound and message display.

However, in a house, a user is not always present near an electronic device that attempts to perform notification. As a result, the notification issued by a domestic electronic device may not be transmitted to the user with a known method of notification.

An object of the disclosure is to provide a notification control device, a notification control system, and a notification control method, which are able to notify a user in a house of information related to electronic devices.

A notification control device according to the disclosure includes a controller configured to determine a notification execution device for executing a notification, and a storage unit configured to store a plurality of electronic devices capable of executing the notification. The controller includes a notification data acquisition unit configured to acquire notification data related to the notification. In a case where the notification data acquisition unit acquires the notification data, the controller determines the notification execution device from among the plurality, of electronic devices stored in the storage unit based on a prescribed condition.

A notification control system according to the disclosure includes a controller configured to determine a notification execution device for executing a notification, and a storage unit configured to store a plurality of electronic devices capable of executing the notification. The controller includes a notification data acquisition unit configured to acquire notification data related to the notification. In a case where the notification data acquisition unit has acquired the notification data, the controller determines the notification execution device from among the plurality of electronic devices stored in the storage unit based on a prescribed condition, and causes the determined notification execution device to execute the notification based on the notification data.

A notification control method according to the disclosure includes a notification data acquisition step in which a notification data acquisition unit acquires notification data related to a notification, and a notification execution device determination step in which a controller determines, based on a prescribed condition, a notification execution device configured to execute the notification from among a plurality of electronic devices stored in a storage unit.

A notification control program of the disclosure causes a computer to perform the notification control described above.

According to the disclosure, it is possible to notify a user present in a house of information related to electronic devices.

### BRIEF DESCRIPTION OF DRAWINGS

The disclosure will be described with reference to the accompanying drawings, wherein like numbers reference like elements.

FIG. 1 is a diagram illustrating a notification control system according to a first embodiment of the disclosure.

FIG. 2 is a block diagram illustrating a configuration of the notification control system according to the first embodiment of the disclosure.

FIG. 3 is a flowchart of notification control of the first embodiment of the disclosure.

FIG. 4 is a diagram illustrating a notification control device according to a second embodiment of the disclosure.

FIG. 5 is a block diagram illustrating a configuration of the notification control device of the second embodiment of the disclosure.

FIG. 6 is a flowchart of notification control of the second embodiment of the disclosure.

### DESCRIPTION OF EMBODIMENTS

Embodiments of the disclosure will be described with reference to the drawings. Note that in the drawings, the same reference signs are assigned to the same or corresponding constituent elements, and descriptions thereof will not be repeated.

Notification control systems 100 and 200 according to the embodiments described below each include a controller configured to determine a notification execution device to execute notification related to an electronic device, and a storage unit configured to store electronic devices capable of executing the notification. The controller includes a notification data acquisition unit configured to acquire notification data related to states or the like of the electronic devices. In a case that the notification data acquisition unit acquires notification data, the controller determines a notification execution device from among the electronic devices stored in the storage unit based on a prescribed condition, converts the notification data related to the state or the like of the electronic device to a form of information easy to understand, such as image display, a text message or a sound, and then causes the notification execution device to execute the notification.

### First Embodiment

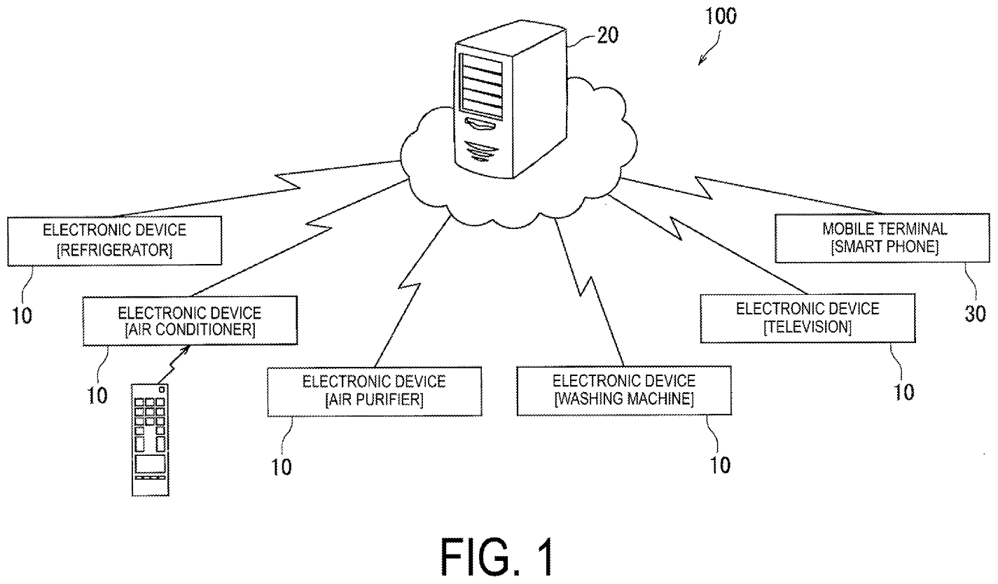

FIG. 1 is a diagram illustrating a notification control system 100 according to the present embodiment. Specifically, FIG. 1 illustrates a home network configured by a plurality of electronic devices 10, such as smart home appliances.

As illustrated in FIG. 1, the notification control system 100 of the present embodiment includes the plurality of electronic devices 10 connectable with the Internet, and a server 20 on a cloud. The notification control system 100 of the present embodiment further includes a mobile terminal 30 for communications.

Each of the electronic devices 10 is an electronic device primarily used within a house for household use (a so-called home appliance or consumer electronics product), and is a consumer electronics product called an IoT home appliance or a smart home appliance equipped with a network communication function.

In FIG. 1, a refrigerator (freezer refrigerator), a washing machine, a television, an air conditioner, and an air purifier are described as examples of representative domestic electronic devices 10. In addition, the notification control system 100 may include other IoT home appliances or smart home appliances.

Other home appliances may include, for example, air-conditioning home appliances such as a humidifying air purifier and a dehumidifying air purifier, kitchen home appliances such as a rice cooker and an oven cooking range, everyday-life home appliances such as a vacuum cleaner, AV appliances such as an audio device, and home information appliances such as a personal computer and a smart speaker.

Each of the electronic devices 10 and the server 20 are connected to each other via an in-home intranet such as a LAN, and an external network such as the Internet. The connection may be a wireless or wired connection, or a combination thereof.

The server 20 is communicably connected to each of the electronic devices 10 via the Internet. In the present embodiment, the server 20 is an example of a notification control device.

In the notification control system 100 of the present embodiment, each of the electronic devices 10 transmits, to the server 20, notification data related to the state of the electronic device in addition to identification information for identifying that electronic device 10.

The notification data is data related to the operation status or the like of the electronic device. Each electronic device 10 transmits notification data to the server 20 when no person is present near that device. For example, in a case where the electronic device 10 is a washing machine, the washing machine may be configured such that, when the washing machine has finished washing and notified a user in its surrounding of information (also referred to as the status or state) indicating the finish of washing but a corresponding operation such as opening a lid of the washing drum is not carried out for a prescribed period of time by the user, the washing machine transmits notification data to the server 20 in order to notify the user of information such as a message indicating that washing is finished from other devices.

As another example, in a case where the electronic device 10 is an oven cooking range, the oven cooking range transmits, to the server 20, data or a signal indicating the finish of cooking as the notification data. Further, in a case where the electronic device 10 is a refrigerator, the refrigerator transmits, to the server 20, data or a signal indicating the finish of frost removal as the notification data.

When the server 20 has acquired the notification data from any of the electronic devices 10, the server 20 inquires, of the electronic devices, an electronic device other than the electronic device having issued the notification data (notification request device), which is installed in a specified place or room within the house, whether any person is present in the surroundings thereof. As a result, the server 20 acquires a human detection result indicating presence or absence of human detection.

Next, the server 20 ranks the electronic devices 10 on the basis of the human detection result, except for the notification request device, which are able to execute the notification in the order of levels of certainty of a person being present in the surroundings, in other words, in descending order of the probability of presence of a person in the surroundings, as a priority order for the notification execution.

Thereafter, the server 20 determines each of the electronic devices 10 as a notification execution device for executing the notification in sequence initially from the electronic device 10 ranked highest in the priority order, and causes the determined notification execution device to execute the notification.

For example, in a case where the notification request device is a washing machine installed in a washroom, the server 20 determines a refrigerator having detected a person in the kitchen as the notification execution device based on the notification execution priority order described above. Then, the server 20 transmits the notification data to the refrigerator to cause the refrigerator to execute the notification.

In this manner, the notification control system 100 of the present embodiment is able to transmit, to a user, notification data issued from one electronic device 10 from another electronic device 10 near the user at a position distanced from the one electronic device 10 by causing the another electronic device to execute the notification.

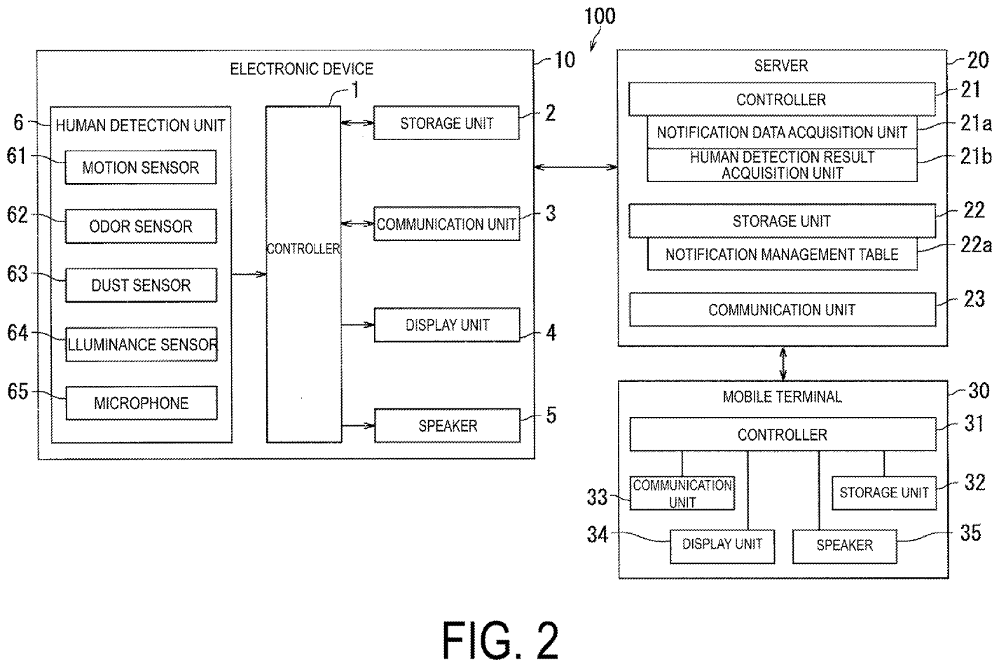

Next, a configuration of the notification control system 100 will be described with reference to FIG. 2. FIG. 2 is a block diagram illustrating the configuration of the notification control system 100 of the present embodiment.

For the electronic devices 10, functional features specific to each household electronic device 10 such as a refrigeration and freezing function, a cooking function, a household function, and an air-conditioning function will not be described, and only configurations involved in notification control will be described.

As illustrated in FIG. 2, the electronic device 10 includes a controller 1, a storage unit 2, a communication unit 3, a display unit 4, a speaker 5, and a human detection unit 6. The display, unit 4 and the speaker 5 are both examples of a notification unit configured to notify a user of notification information obtained by converting the notification data.

The controller 1 includes a processor such as a central processing unit (CPU). The processor controls each unit of the electronic device 10 based on a program stored in the storage unit 2.

Specifically, in a case where any of the electronic devices 10 issues notification data, the controller 1 of the electronic device 10 controls the acquisition of the notification data and the acquisition of a human detection result related to a prescribed region (for example, the interior of a room).

The storage unit 2 includes a main storage device such as a semiconductor memory, and an auxiliary storage device such as a semiconductor memory and/or a hard disk drive. The storage unit 2 stores data and programs.

The communication unit 3 includes a receiver and a transmitter as ports through which signals or data can be transmitted and received to/from the server 20 via a network line. The receiver receives notification data generated by the other electronic devices via the server 20. The transmitter transmits notification data generated by the own device to the server 20.

In a case where the electronic device 10 is an everyday-life home appliance such as a refrigerator, a washing machine, an air conditioner, or an air purifier, the display unit 4 uses an LED panel that also serves as an operation unit (hereinafter, referred to as a touch display).

In a case where the electronic device 10 is an electronic device provided with a display or a touch display, the display or the touch display is used as the display unit 4 of the electronic device 10. In a case where the electronic device 10 is an electronic device provided with a remote controller (“remote”), a display or a touch display of the remote controller may be used as the display unit 4.

The speaker 5 speaks notification information obtained by converting notification data, as an informing unit of the electronic device 10. Alternatively, the speaker 5 may generate an alarm sound as a notification.

A method for notifying the information based on the notification data may be such that, for example, the speaker 5 speaks the information and the display unit performs only flashing. In addition, the method for the notification may be such that only an alarm sound is generated from the speaker 5 and the display unit 4 displays the information based on the notification data.

Next, the human detection unit 6 of the electronic device 10 will be described by using an air-conditioning device such as an air purifier or an air conditioner as an example.

In FIG. 2, the human detection unit 6 mounted in an air-conditioning device is illustrated. The human detection unit 6 detects whether any person is present (human detection result) in the vicinity of a location where the electronic device 10 (the air-conditioning device) is disposed, which is a detection target region, by using various types of sensors individually or in combination.

In other words, the human detection unit 6 detects the presence/absence of the user (indoor information) in a specific room in the house where the electronic device 10 (own device) is installed (indoors). The obtained human detection result (indoor information) is transmitted to the server 20 via a transmitter 3B.

In this case, it is possible to associate the human detection result with both a management number of the location (room) in which the electronic device 10 (hereinafter referred to as own device) is installed and a management number allocated to the own device in advance, and transmit the human detection result. At the transmission, additional information associated with a detection start time when a person was detected, a detection end time when no person is detected anymore, and the like may be transmitted to the server 20.

In addition, at the transmission, a detection integration time may be associated and transmitted to the server 20. The detection integration time is calculated by summing time intervals from the start of detection to the end of detection.

As illustrated in FIG. 2, the human detection unit 6 of the air-conditioning device includes a motion sensor 61, an odor sensor 62, a dust sensor 63, an illuminance sensor 64, and a microphone (sound sensor) 65.

The motion sensor 61 detects whether any person is present near the location where the electronic device 10 is installed. In other words, the motion sensor 61 detects the presence/absence of the user in the room (indoor information). The detection method of the motion sensor 61 is not particularly limited. Any infrared or ultrasonic detection method may be used.

The odor sensor 62 detects an odor level in the room where the electronic device 10 is installed. The odor sensor 62 is, for example, a quartz vibration type sensor or a semiconductor type sensor. The odor sensor 62 detects the presence/absence of the user in the room based on a change in the odor level inside the room.

The dust sensor 63 detects the amount of dust (tiny particles or debris) in the room in which the electronic device 10 is installed. The dust sensor 63 detects the presence/absence of the user in the room based on a change in the amount of dust inside the room.

The illuminance sensor 64 detects the illuminance inside the room in which the electronic device 10 is installed. The illuminance sensor 64 detects the presence/absence of the user in the room based on the illuminance inside the room. In the case of human-presence detection use, the electronic device 10 may include a function of learning and storing changes in illuminance depending on the time periods of everyday life.

The microphone 65 detects sound inside the room in which the electronic device 10 is installed. The microphone 65 detects the presence/absence of the user in the room based on a change in sound volume or sound pressure inside the room.

In FIG. 2 illustrates sensors and a microphone mounted on an air purifier. The IoT home appliance or smart home appliance connected to the in-home network may include all the sensors and the microphone, or may include some thereof. The electronic device 10 includes at least the motion sensor 61.

Next, the server 20 of the notification control system 100 will be described. As illustrated in FIG. 2, the server 20 includes a controller 21, a storage unit 22, and a communication unit 23.

The controller 21 includes a processor such as a CPU. The processor of the controller 21 controls each configuration of the server 20 by executing a program stored in the storage unit 22. The controller 21 may give instructions, commands, inquiries, or the like to each of the electronic devices 10.

In the present embodiment, the controller 21 of the server 20 includes a notification data acquisition unit. 21a and a human detection result acquisition unit 21b. The notification data acquisition unit 21a acquires, via the network, notification data regarding the state of the electronic device. The human detection result acquisition unit 21b acquires, via the human detection unit 6 of each of the electronic devices 10, a human detection result in a prescribed region (e.g., the interior of a room) for each electronic device 10.

The controller 21 causes the storage unit 22 to store operation data regarding each electronic device 10, the identification information for identifying each electronic device 10, and other information transmitted from the controller 1 of each electronic device 10.

The storage unit 22 includes a main storage device such as a semiconductor memory, and an auxiliary storage device such as a semiconductor memory and/or a hard disk drive. The storage unit 22 stores a control program used for controlling operations of each unit of the server 20. The control program stored in the storage unit 22 is executed by the controller 21.

In the present embodiment, the storage unit 22 of the server 20 stores the human detection results transmitted from each of the electronic devices 10. Specifically, the individual human detection result s for each of the electronic devices 10 acquired by the human detection result acquisition unit 21b are associated with the identification information for identifying each electronic device 10, and registered as a notification management table 22a.

In addition, a detection start time at which a person was detected, a detection end time at which no person is detected anymore, and other information may be associated with the identification information of each of the electronic devices 10, and be registered in the notification management table 22a.

The communication unit 23 communicates with a communication device conforming to the same communication standard. For example, the communication unit 23 is a local area network (LAN) adapter conforming to the LAN standard. The communication unit 23 communicates with each of the electronic devices 10 illustrated in FIG. 1 via a network such as the Internet or an intranet.

In the present embodiment, the communication unit 23 of the server 20 receives, via the network, notification data and human detection results generated by each of the electronic devices 10. In a case where a notification execution device for executing the notification is determined, the communication unit 23 transmits the notification data to the notification execution device.

Next, a mobile terminal. 30 will be described with reference to FIG. 2. In the present embodiment, the mobile terminal 30 is a mobile phone such as a smart phone.

The configuration of the mobile terminal 30 will be described briefly. The mobile terminal 30 includes a controller 31, a storage unit 32, a communication unit 33, a display unit 34, and a speaker 35.

The controller 31 controls each unit of the mobile terminal 30. The storage unit 32 stores data and programs. The communication unit 33 performs communication over a network line or a telephone line. As the display unit 34 and the speaker 35, the display unit and the speaker built into a smart phone are used.

In a case where the mobile terminal 30 is a smart phone, identification information such as an e-mail address or a phone number of the smart phone is stored (registered) in advance in the server 20 as prescribed contact information or emergency contact information.

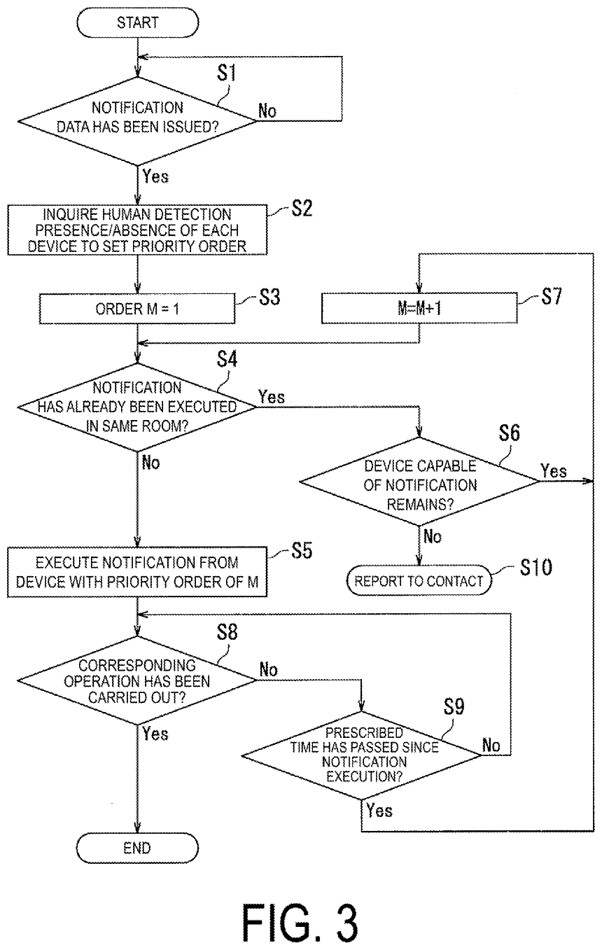

Next, processing of the notification data and execution of the notification will be described with reference to a flowchart and Tables 1 to 3. FIG. 3 is a flowchart illustrating notification control processing in the present embodiment.

“Table 1” is an example of the notification management table 22a in the present embodiment. Table 1 is a table (list) for the electronic devices 10 connected to the home network (the notification control system 100). In the table, a room number as installation location information and a “notification execution priority order” for each time period set for each household are registered for each preset device number (management number) as basic items to be managed by the controller 21.

TABLE 1

| | | | | | Notification priority | | |
|---|---|---|---|---|---|---|---|
| | | | | | order for each time period | | |
| Device | | Home appliance | Installation | Room | 6:00- | 15:00- | 21:00- |
| No. | Product name | group | location | No. | 15:00 | 21:00 | 6:00 |
| 001 | Television A | AV home appliance | Living area | 01 | 6 | 6 | 1 |
| 002 | Air | Air-conditioning | Living area | 01 | 7 | 7 | 2 |
| | conditioner A | home appliance | | | | | |
| 003 | Humidifying air | Air-conditioning | Living area | 01 | 8 | 8 | 3 |
| | purifier | home appliance | | | | | |
| 004 | Air | Air-conditioning | Dining room | 02 | 1 | 4 | 11 |
| | conditioner B | home appliance | | | | | |
| 005 | Air purifier A | Air-conditioning | Dining room | 02 | 2 | 5 | 12 |
| | | home appliance | | | | | |
| 006 | Refrigerator | Kitchen home | Kitchen | 03 | 3 | 1 | 13 |
| | | appliance | | | | | |
| 007 | Rice cooker | Kitchen home | Kitchen | 03 | 4 | 2 | 14 |
| | | appliance | | | | | |
| 008 | Oven cooking | Kitchen home | Kitchen | 03 | 5 | 3 | 15 |
| | range | appliance | | | | | |
| 009 | Washing machine | Everyday-life | Washroom | 04 | 9 | 9 | 16 |
| | | home appliance | | | | | |
| 010 | Television B | AV home appliance | Living room | 05 | 10 | 10 | 4 |
| | | | A | | | | |
| 011 | Air | Air-conditioning | Living room | 05 | 11 | 11 | 5 |
| | conditioner C | home appliance | A | | | | |
| 012 | Air purifier B | Air-conditioning | Living room | 05 | 12 | 12 | 6 |
| | | home appliance | A | | | | |
| 013 | Air | Air-conditioning | Living room | 06 | 13 | 13 | 7 |
| | conditioner D | home appliance | B | | | | |
| 014 | Air purifier C | Air-conditioning | Living room | 06 | 14 | 14 | 8 |
| | | home appliance | B | | | | |
| 015 | Air | Air-conditioning | Living room | 07 | 15 | 15 | 9 |
| | conditioner E | home appliance | C | | | | |
| 016 | Air purifier D | Air-conditioning | Living room | 07 | 16 | 16 | 10 |
| | | home appliance | C | | | | |
| 017 | Air | Air-conditioning | Children's | 08 | Excluded | 17 | Excluded |
| | conditioner F | home appliance | room A | | | | |
| 018 | Air purifier E | Air-conditioning | Children's | 08 | Excluded | 18 | Excluded |
| | | home appliance | room A | | | | |
| 019 | Vacuum cleaner | Everyday-life | Closet/ | 09 | 17 | 19 | Excluded |
| | | home appliance | corridor | | | | |
| 020 | Dehumidifying air | Air-conditioning | Closet/ | 09 | 18 | 20 | Excluded |
| | purifier | home appliance | corridor | | | | |
| [symbol] [symbol] | [symbol] [symbol] [symbol] [symbol] [symbol] [symbol] | [symbol] [symbol] [symbol] | [symbol] [symbol] [symbol] [symbol] | [symbol] [symbol] | [symbol] [symbol] | [symbol] [symbol] | [symbol] [symbol] |

In Table 1, for example, in the morning time period (6:00-15:00), as for the “notification priority order”, the priority order of the electronic device 10 disposed in the “dining room”, “kitchen”, or the like where the probability of presence of a person is considered high is set to be higher. Conversely, the notification priority order of the electronic device 10 disposed in each “living room”, such as a bedroom or a Japanese-style room, where the probability of presence of a person is considered low in the morning time period, is set to be lower.

As for an electronic device 10 disposed in a location where the probability of presence of a person is considered low in all the time periods, such as a closet (storeroom) or a corridor, the notification priority order thereof is set to be relatively low, or the device is excluded from the priority order. The “children's room” is treated differently, and is excluded from the “notification” regarding household duties except for the daytime time period (15:00-21:00).

### Specific Example 1

Specific Example 1 of the notification control will be described below while using the notification management table 22a in Table 1. Specific Example 1 is described by exemplifying a case in which notification data is generated indicating that a washing process is finished in the morning time period (6:00-15:00) by the washing machine (device number “009”) installed in a washroom (room number 04).

First, as illustrated in the flowchart of FIG. 3, when the notification control (notification process) is started, in step S1, the controller 21 functioning as a notification controller performs notification issue confirmation in which it is confirmed whether notification data issued by any of the electronic devices 10 is contained in data or a signal received by the communication unit 23, that is, whether any of the electronic devices 10 has issued notification data.

In step S1, in a case where the result of the notification issue confirmation is “No”, that is, no notification data sent from the other devices has been issued from any of the electronic devices 10, the controller 21 repeats the notification issue confirmation in step S1 until any of the electronic devices 10 issues notification data.

In a case where one of the electronic devices (a notification request device; the washing machine in this case) has issued notification data (the determination in step S1 is “Yes”), the controller 21 executes a notification execution device determination process (step S2 to step S6) in which, from among the electronic devices registered in the notification management table 22a and capable of executing a notification, the electronic device for executing the notification (referred to as notification execution device) is determined based on the human detection results for each of the electronic devices 10 acquired by the human detection result acquisition unit 21b.

The notification execution device determination process will be described below with reference to FIG. 3 and “Table 2”. First, the controller 21 creates a list “Table 2”, which indicates the “order of the electronic devices highly likely to execute the notification”, based on the results of “human detection” having been inquired of each of the electronic devices 10 based on the notification management table 22a (Table 1).

TABLE 2

| | | | | | | | Priority order |
|---|---|---|---|---|---|---|---|
| Device | | Home appliance | Installation | Room | Priority order | Person | of notification |
| No. | Product name | group | location | No. | 6:00-15:00 | detected? | execution |
| 009 | Washing machine | Everyday-life | Washroom | 04 | Notification | No | No |
| | | home appliance | | | source | | |
| 004 | Air | Air-conditioning | Dining room | 02 | 1 | OFF | — |
| | conditioner B | home appliance | | | | | |
| 005 | Air purifier A | Air-conditioning | Dining room | 02 | 2 | No | — |
| | | home appliance | | | | | |
| 006 | Refrigerator | Kitchen home | Kitchen | 03 | 3 | Yes | First |
| | | appliance | | | | | |
| 007 | Rice cooker | Kitchen home | Kitchen | 03 | 4 | OFF | — |
| | | appliance | | | | | |
| 008 | Oven cooking | Kitchen home | Kitchen | 03 | 5 | OFF | — |
| | range | appliance | | | | | |
| 001 | Television A | AV home appliance | Living area | 01 | 6 | OFF | — |
| 002 | Air | Air-conditioning | Living area | 01 | 7 | Yes | Second |
| | conditioner A | home appliance | | | | | |
| 003 | Humidifying air | Air-conditioning | Living area | 01 | 8 | OFF | — |
| | purifier | home appliance | | | | | |
| 010 | Television B | AV home appliance | Living room | 05 | 9 | OFF | — |
| | | | A | | | | |
| 011 | Air | Air-conditioning | Living room | 05 | 10 | OFF | — |
| | conditioner C | home appliance | A | | | | |
| 012 | Air purifier B | Air-conditioning | Living room | 05 | 11 | Yes | Third |
| | | home appliance | A | | | | |
| 013 | Air | Air-conditioning | Living room | 06 | 12 | OFF | — |
| | conditioner D | home appliance | B | | | | |
| 014 | Air purifier C | Air-conditioning | Living room | 06 | 13 | Yes | Fourth |
| | | home appliance | B | | | | |
| 015 | Air | Air-conditioning | Living room | 07 | 14 | No | — |
| | conditioner E | home appliance | C | | | | |
| 016 | Air purifier D | Air-conditioning | Livina room | 07 | 15 | No | — |
| | | home appliance | C | | | | |
| 019 | Vacuum cleaner | Everyday-life | Closet/ | 09 | 16 | OFF | — |
| | | home appliance | corridor | | | | |
| 020 | Dehumidifying air | Air-conditioning | Closet/ | 09 | 17 | No | — |
| | purifier | home appliance | corridor | | | | |
| 017 | Air | Air-conditioning | Children's | 08 | Excluded | OFF | — |
| | conditioner F | home appliance | room A | | | | |
| 018 | Air purifier E | Air-conditioning | Children's | 08 | Excluded | No | — |
| | | home appliance | room A | | | | |
| [symbol] [symbol] | [symbol] [symbol] [symbol] [symbol] [symbol] | [symbol] [symbol] [symbol] | [symbol] [symbol] [symbol] [symbol] | [symbol] [symbol] | [symbol] [symbol] | [symbol] [symbol] | [symbol] [symbol] |

A setting method for a specific “notification execution priority order” (Table 2) will be described. In step S2 of the flowchart in FIG. 3, the controller 21 first executes a human detection result confirmation process in which the controller 21 inquires the presence/absence of human detection of all the electronic devices 10 (see Table 1) connected to the network simultaneously.

Then, in the human detection result confirmation process, the “notification execution priority order” is set only for each of the electronic devices that have replied with data of human detection being “Yes” in sequence from the electronic device ranked higher in the “priority order for each time period” in Table 1.

For example, as illustrated in Table 2, in the human detection result confirmation process, in a case where a reply indicating human detection as “Yes” is acquired from four devices including the refrigerator (device number “006”, room number “03”, kitchen), the air conditioner A (device number “002”, room number “01”, living area), the air purifier B (device number “012”, room number “05”, living room A), and the air purifier C (device number “014”, room number “06”, living room B), the controller 21 sets the priority order of “first” to “fourth”, as the priority order at the notification data generation time, in sequence from the electronic device ranked higher in the priority order for each time period (6:00-15:00), and stores the set priority order in the storage unit 22.

In Table 2, an electronic device that is powered off and does not reply with a human detection result is indicated by “OFF”.

Next, the controller 21 sequentially causes each of the electronic devices 10 set to be “first” to “fourth” based on the stored “priority order of notification execution” (Table 2), to execute the notification.

As a specific procedure of the notification execution, first, in step S3 of the flowchart illustrated in FIG. 3, a value of “1” (first) is substituted into a variable M for determining the priority order of the notification execution devices.

Next, in step S4, the controller 21 executes a repeated-notification suppression confirmation process in which, in order to suppress the notification being repeated the same room, it is confirmed whether the notification has already been executed in the same room (location) as the room where the electronic device 10 with the priority order set to the order of M (in this case, “first”) is disposed.

The repeated-notification suppression confirmation process may be carried out by confirming, for example, whether there is a record indicating that the notification has already been executed by the electronic device having the same room number on the priority order list.

In step S4, in a case where it is confirmed that no notification has been executed yet in the same room (location) (“No” in step S4), the controller 21 determines the electronic device with the priority order of “first” as the notification execution device, and causes the determined device to execute the notification in step S5.

On the other hand, in step S4, in a case where it is confirmed that the notification has already been executed in the same room (location) (“Yes” in step S4), the controller 21 confirms in step S6 whether there remains an electronic device to which an inquiry about the human detection result can be sent, that is, confirms whether the repeat of notification is confirmed until the last electronic device capable of notification is taken into consideration in the “notification execution priority order” list (Table 2).

In step S6, in a case where an electronic device capable of executing the notification still remains (“Yes” in step S6), the controller 21, in step S7, adds one to the variable M, which is the order of inquiry. That is, hereinafter, the confirmation of whether the notification can be executed is continued with respect to the electronic device 10 with the priority order of “M+1” (in this case, “second”).

On the other hand, in step S6, in a case where no electronic device capable of executing the notification remains (“No” in step S6), the controller 21, in step S10, reports the content of the notification data to the mobile terminal 30 in an external network, such as a smart phone for which contact information such as an email address has been registered in advance, and then terminates the process.

The notification device determination process carried out in step S4 to step S6 as described above is continued until the notification is executed, as step S5, by any of the electronic devices, or the notification data is transmitted, cis step S10, to the external mobile terminal 30.

Next, when the notification execution device determination process (steps S2 to S6) is complete and the notification is executed in step S5, the controller 21 performs a corresponding operation confirmation decision process in steps S8 and S9 of the flowchart in which it is confirmed whether a “corresponding operation” which is an operation corresponding to the notification by the user has been carried out.

In the corresponding operation confirmation decision process, first, it is confirmed in step S8 whether the corresponding operation has been carried out by the user on the electronic device (in this case, the washing machine) that issued the notification data.

In step S8, when the corresponding operation, such as opening or closing the lid of the washing machine, has been carried out (“Yes” in step S8), the controller 21 completes all of the corresponding operation confirmation decision process and the notification process, and then terminates the notification control (end).

In step S8, when the corresponding operation by the user is not confirmed (“No” in step S8), the controller 21 confirms in step S9 whether a prescribed time has passed since the execution of the notification (step S5).

The confirmation of whether the prescribed time has passed since the execution of the notification in step S9 is performed in order to make sure whether the notification was definitely transmitted to the user and thereafter the user has taken an appropriate action. For this reason, a time of approximately 1 to 10 minutes, for example, is set as the prescribed time.

In the corresponding operation confirmation decision from step S8 to step S9, in a case where the length of a state in which no corresponding operation is carried out by the user is less than the prescribed time when measured from the execution of the notification (step S5) (“No” in step S9), the controller 21 returns to step S8 to continue the confirmation of the presence or absence of the corresponding operation by the user. When the corresponding operation is confirmed (“Yes” in step S8), the corresponding operation confirmation decision process is terminated (end).

Further, in step S9, in a case where the length of the state in which no corresponding operation is carried out by the user is equal to or longer than the prescribed time when measured from the execution of the notification, (“Yes” in step S9), the controller 21 returns to step S7 of the notification execution device determination process, and adds one to the variable M, which refers to the priority order of notification execution.

Then, the controller 21, again, following the priority order in sequence, iterates the repeated-notification suppression confirmation process (step S4) and the confirmation of whether there remains an electronic device capable of notification (step S6) until no confirmation target device capable of notification is present.

As described above, the notification control system 100 is able to directly report, to the user, the notification issued by one of the electronic devices 10, which is a notification request source, by the notification from a notification execution device installed in a remote room.

In the notification control system 100 of the first embodiment, when the notification is data related to abnormalities, malfunctions, or the like of an electronic device, the controller 21 causes all of the electronic devices 10 capable of executing a notification to execute the notification regardless of the time period.

In Specific Example 1 (Table 2), the notification control is described exemplifying a case in which only one electronic device 10 running with its power being on is present in each room. However, a plurality of electronic devices 10 capable of executing a notification may be present simultaneously in a single room in some cases. In such case, the notification control system 100 does not execute the notification two times successively in the same room, and attempts to cause another electronic device 10 in charge of detecting a person in another room to execute the notification. Specific Example 2 below is an example of the case discussed above.

### Specific Example 2

Notification control of Specific Example 2 will be described with reference to Table 3 and the flowchart in FIG. 3. Table 3, like Table 2, is a “notification execution priority order” list created based on the results obtained by inquiring the presence/absence of the human detection results of the electronic devices 10 registered in the notification management table 22a (Table 1).

The list of “notification execution priority order” in Table 3 is different from Table 2 in that the stated list is a list directed to the night time period (21:00-6:00 next day).

In Specific Example 2, an example is given of a case in which, in a refrigerator (device number “006”) installed in a kitchen (room number “03”), notification data is generated indicating that the door of the cool storage space is open (forget to close) during the night time period.

In Specific Example 2 as well, in step S1, in a case where the result of the notification issue confirmation is “No”, that is, no notification data from the other devices has been issued from any of the electronic devices 10, the controller 21 of the server 20 configured to function as a notification controller repeats the notification issue confirmation in step S1 until any of the electronic devices 10 issues notification data.

In a case where one of the electronic devices (a notification request device; a refrigerator in this case) has issued notification data (the determination in step S1 is “Yes”, that is, in a case where the notification data acquisition unit 21a has acquired notification data, the controller 21 executes the notification execution device determination process (step S2 to step S6) in which, from among the electronic devices registered in the notification management table 22a and capable of executing notification, an electronic devices configured to execute a notification referred to as a notification execution device) is determined based on the human detection results for each of the electronic devices 10 acquired by the human detection result acquisition unit 21b.

For example, when notification data is received from the refrigerator in the night time period, the controller 21 creates a “notification execution priority order” list as illustrated in “Table 3” in the same manner as in Specific Example 1, and stores the list in the storage unit 22.

TABLE 3

| | | | | | | | Priority order |
|---|---|---|---|---|---|---|---|
| Device | | Home appliance | Installation | Room | Priority order | Person | of notification |
| No. | Product name | group | location | No. | 21:00-6:00 | detected? | execution |
| 006 | Refrigerator | Kitchen home | Kitchen | 03 | Notification | No | No |
| | | appliance | | | source | | |
| 001 | Television A | AV home appliance | Living area | 01 | 1 | OFF | — |
| 002 | Air | Air-conditioning | Living area | 01 | 2 | Yes | First |
| | conditioner A | home appliance | | | | | |
| 003 | Humidifying air | Air-conditioning | Living area | 01 | 3 | Yes | (Second) |
| | purifier | home appliance | | | | | |
| 010 | Television B | AV home appliance | Living room | 05 | 4 | OFF | — |
| | | | A | | | | |
| 011 | Air | Air-conditioning | Living room | 05 | 5 | Yes | Third |
| | conditioner C | home appliance | A | | | | |
| 012 | Air purifier B | Air-conditioning | Living room | 05 | 6 | Yes | (Fourth) |
| | | home appliance | A | | | | |
| 013 | Air | Air-conditioning | Living room | 06 | 7 | OFF | — |
| | conditioner D | home appliance | B | | | | |
| 014 | Air purifier C | Air-conditioning | Living room | 06 | 8 | OFF | — |
| | | home appliance | B | | | | |
| 015 | Air | Air-conditioning | Living room | 07 | 9 | OFF | — |
| | conditioner E | home appliance | C | | | | |
| 016 | Air purifier D | Air-conditioning | Living room | 07 | 10 | OFF | — |
| | | home appliance | C | | | | |
| 004 | Air | Air-conditioning | Dining room | 02 | 11 | OFF | — |
| | conditioner B | home appliance | | | | | |
| 005 | Air purifier A | Air-conditioning | Dining room | 02 | 12 | OFF | — |
| | | home appliance | | | | | |
| 007 | Rice cooker | Kitchen home | Kitchen | 03 | 13 | OFF | — |
| | | appliance | | | | | |
| 008 | Oven cooking | Kitchen home | Kitchen | 03 | 14 | OFF | — |
| | range | appliance | | | | | |
| 009 | Washing machine | Everyday-life | Washroom | 04 | 15 | OFF | — |
| | | home appliance | | | | | |
| 017 | Air | Air-conditioning | Children's | 08 | Excluded | Yes | — |
| | conditioner F | home appliance | room A | | | | |
| 018 | Air purifier E | Air-conditioning | Children's | 08 | Excluded | Yes | — |
| | | home appliance | room A | | | | |
| 019 | Vacuum cleaner | Everyday-life | Closet/ | 09 | Excluded | OFF | — |
| | | home appliance | corridor | | | | |
| 020 | Dehumidifying air | Air-conditioning | Closet/ | 09 | Excluded | No | — |
| | purifier | home appliance | corridor | | | | |
| [symbol] [symbol] | [symbol] [symbol] [symbol] [symbol] [symbol] | [symbol] [symbol] [symbol] | [symbol] [symbol] [symbol] [symbol] | [symbol] [symbol] | [symbol] [symbol] | [symbol] [symbol] | [symbol] [symbol] |

In consideration of living hours, the priority order of “living area”, “living room”, and the like is set Lo be higher in the list of Table 3. In addition, the priority order of “dining room”, “kitchen”, “washroom”, and the like, where the probability that any person is present at night is assumed to be low, is set to be lower. Further, in Specific Example 2, human detection is skewed toward the living area (room number “01”) and the living room A (room number “05”)

In this case, it is assumed that, in the notification execution device determination process (steps S2 to S6), the controller 21 first caused the air conditioner A (device number “002”, room number “01”, installation location “living area”) with the priority order of “first” to execute the notification, for example.

Subsequently, in the corresponding operation confirmation decision process (steps S8, S9) after the notification execution (step S5), in a case where a prescribed time has passed (“Yes” in step S9) since the notification execution in a state where no corresponding operation is carried out by the user (“No” in step S8), the controller 21 performs count-up processing to raise the priority order by one (N=N+1) in step S7, similarly to Specific Example 1.

Then, in step S4, the controller 21 executes the repeated-notification suppression confirmation process to confirm whether the humidifying air purifier (device number “003”) with the priority order of “M+1” (“second” in this case) is capable of notification.

At this time, the installation location (room number “01”, living area) of the air conditioner A (device number “002”) having executed the notification and the installation location (room number “01”, living area) of the humidifying air purifier (device number “003”) ranked highest in the current priority order matches, and therefore the controller 21 determines in step S4 that the notification has already been executed in the same room (“Yes” in step S4).

That is, the notification in the living area (room number “01”) of the humidifying air purifier (device number “003”) with the priority order of “second” is not executed, and the process moves to step S6, in which it is confirmed whether an electronic device capable of notification still remains.

The repeated-notification suppression confirmation process in step S4 may be carried out by deciding whether there is a record indicating that the notification has already been executed by the electronic device having the same room number on the priority order list (Table 3).

Alternatively, in a case where, for example, the controller 1 of the electronic device 10 including the microphone 65 recognizes or records the sound of the notification in the same room, the recording may be used to confirm the repeated-notification suppression.

Subsequently to step S4, the flow of the process after the notification is executed is the same as that of Specific Example 1. That is, in a case of “Yes” in step S4, the controller 21 confirms in step S6 whether there remains an electronic device to which an inquiry about the human detection result can be sent.

In a case of “No” in step S6, the controller 21 reports the content of the notification data to the mobile terminal 30 in the external network, and then terminates the process (step S10). In contrast, in a case of “Yes” in step S6, the controller 21 performs count-up processing on the variable N, which refers to the priority order, by one (“M+1”), and continues to confirm whether the notification can be executed regarding the electronic device with the subsequent priority order.

Further, after executing the notification in step S5, the corresponding operation confirmation decision process is performed in steps S8 and S9. Then, in a case where the corresponding operation has been carried out (“Yes” in step S8), the controller 21 terminates the notification control (end). In a case where the corresponding operation has not been carried out for a prescribed time (“Yes” in step S9), the process returns to step S6 to continue performing the notification execution device determination process (steps S2 to S6).

As described above, the notification control system 100 is able to minimize a situation in which notifications having the same content are successively issued a plurality of times in the same room.

Moreover, the notification control system 100 is able to directly report, to the user, the notification data issued by one of the electronic devices 10, which is a notification request source, by notification from a notification execution device installed in a remote room.

In the notification control system 100 of Specific Example 2 as well, when the notification data is data related to abnormalities, malfunctions, or the like of an electronic device, the controller 21 is able to cause all of the electronic devices 10 capable of executing notification to execute the notification at any time.

### Second Embodiment

Next, notification control of a second embodiment will be described with reference to FIGS. 1 to 3 and Tables 1 and 4. “Table 4”, like Tables 2 and 3, is a list indicating an “order of the electronic devices highly capable of execute notification”, which is created based on the result obtained by inquiring the presence/absence of the human detection results of the electronic devices 10 described in the notification management table 22a (Table 1).

The second embodiment differs from the first embodiment in that, when the controller 21 inquires the human detection result of each electronic device 10, the controller 21 acquires, in addition to the human detection result, information of “time of the first detection of a person” and associates this information with the presence/absence of the detection.

Accordingly, “notification execution priority order” in Table 4 described below is different from the priority orders in Tables 2 and 3; in Table 4, the priority order of notification is allocated in order of shortness of the “time passed” from the “time of the first detection of a person”, that is, the priority order of notification is allocated in such a manner that the electronic device that has succeeded in detection of movement a person last (most recently) is allocated with a higher priority order of notification than the others.

Note that in the list of Table 4, the priority order for each time period described in the notification management table 22a (Table 1) is only used for selecting such electronic devices for which inquiring the human detection result of the stated electronic devices is “excluded”. Then, in Table 4, listed are air-conditioning devices in a home such as air conditioners and air purifiers, which are evenly disposed across the rooms and are considered to be operated at relatively high operation rates.

Next, specific notification control using the list of Table 4 will be described with reference to the flowchart in FIG. 3.

In the notification control of the second embodiment, first in step S1, until any of the electronic devices 10 issues the notification data, that is, until the notification issue confirmation result becomes “Yes”, the controller 21 of the server 20 puts the issue of notification data from other devices on standby.

In a case where one of the electronic devices (a notification request device; a refrigerator in this case) has issued notification data (the determination in step S1 is “Yes”), the controller 21 executes the notification execution device determination process (step S2 to step S6) in which, from among the electronic devices registered in the notification management table 22a and capable of executing notification, an electronic devices for executing the notification (notification execution device) is determined based on the human detection results transmitted by each of the electronic devices 10.

For example, when notification data is received from a refrigerator in the kitchen in the night time period, the controller 21 creates a “priority order of notification execution” list as illustrated in “Table 4”, and stores the created list in the storage unit 22.

TABLE 4

| | | | | | | Time when | |
|---|---|---|---|---|---|---|---|
| Device | | Home appliance | Installation | Room | Person | detected a | Priority |
| No. | Product name | group | location | No. | detected? | person | order |
| 006 | Refrigerator | Kitchen home | Kitchen | 03 | No | — | Notification |
| | | appliance | | | | | source |
| 005 | Air purifier A | Air-conditioning | Dining room | 02 | Yes | 3 minutes | First |
| | | home appliance | | | | earlier | |
| 012 | Air purifier B | Air-conditioning | Living room | 05 | No | — | — |
| | | home appliance | A | | | | |
| 014 | Air purifier C | Air-conditioning | Living room | 06 | Yes | 30 minutes | (Fourth) |
| | | home appliance | B | | | earlier | |
| 016 | Air purifier D | Air-conditioning | Living room | 07 | No | — | — |
| | | home appliance | C | | | | |
| 003 | Humidifying | Air-conditioning | Living area | 01 | OFF | — | — |
| | air purifier | home appliance | | | | | |
| 020 | Dehumidifying | Air-conditioning | Closet/ | 09 | No | — | — |
| | air purifier | home appliance | corridor | | | | |
| 002 | Air | Air-conditioning | Living area | 01 | OFF | — | — |
| | conditioner A | home appliance | | | | | |
| 004 | Air | Air-conditioning | Dining room | 02 | Yes | 5 minutes | (Second) |
| | conditioner B | home appliance | | | | earlier | |
| 011 | Air | Air-conditioning | Living room | 05 | No | — | — |
| | conditioner C | home appliance | A | | | | |
| 013 | Air | Air-conditioning | Living room | 06 | Yes | 15 minutes | Third |
| | conditioner D | home appliance | B | | | earlier | |
| 015 | Air | Air-conditioning | Living room | 07 | OFF | — | — |
| | conditioner E | home appliance | C | | | | |
| 017 | Air | Air-conditioning | Children's | 08 | Excluded | — | — |
| | conditioner F | home appliance | room A | | | | |
| 018 | Air purifier E | Air-conditioning | Children's | 08 | Excluded | — | — |
| | | home appliance | room A | | | | |

In the list of Table 4, the air purifier A (device number “005”, room number “02”, installation location “dining room”), air conditioner B (device number “004”, room number “02”, installation location “dining room”), air conditioner D (device number “013”, room number “06”, installation location “living room B”), and air purifier C (device number “014”, room number “06”, installation location “living room B”) are set with the priority orders of first to fourth, respectively, in order of shortness of the “time passed” from the “time when a person was first detected” related to the presence/absence of human detection, among the electronic devices 10 (air-conditioning devices) having replied with human detection results.

Next, the controller 21 carries out steps S3 to S6 of the notification execution device determination process. First, in step S3, the controller 21 substitutes a value of “1” (first) into the variable M for determining the priority order of the notification execution device.

Next, in step S4, the controller 21 executes the repeated-notification suppression confirmation process in which, in order to suppress the notification being repeated in the same room, it is confirmed whether the notification has already been executed in the same room as the room where the electronic device with the priority order of M to execute the notification is disposed.

For example, it is assumed that the controller 21 first caused the air conditioner D (device number “013”, room number “06”, installation location “living room B”) with the priority order of “third” to execute the notification.

Subsequently, in the corresponding operation confirmation decision process (steps S8, S9) after the notification execution (step S5), in a case where the corresponding operation is not carried out by the user, causing step S8 to be “No”, and the subsequent step S9 takes “Yes”, the controller 21 performs count-up processing to raise the priority order by one (M=M+1) in step S7, similarly to Specific Example 2.

Then, in step S7, the controller 21 executes the repeated-notification suppression confirmation process to confirm whether the air purifier C (device number “014”) with the priority order of “M+1” (“fourth.” in this case) is capable of notification.

At this time, the installation location (room number “06”, living room B) of the air conditioner D (device number “013”) having executed the notification (“third”) and the installation location (room number “06”, living room B) of the air purifier C (device number “014”) ranked highest in the current priority order (“fourth”) matches, and therefore the controller 21 determines in step S4 that the notification has already been executed in the same room (“Yes” in step S4).

Because the notification in the living room B (room number “06”) of the air purifier C (device number “014”) with the priority order of “fourth” is not executed and there remains no device capable of notification (“No” in step S6), the controller 21 reports the content of the notification data to the mobile terminal 30 in the external network, and terminates the notification control (end).

The repeated-notification suppression confirmation process in step S4 may be carried out by deciding whether there is a record indicating that the notification has already been executed by the electronic device having the same room number on the priority order list (Table 4).

Alternatively, in a case where, for example, the controller 1 of the electronic device 10 including the microphone 65 recognizes or records the sound of the notification in the same room, the recording may be used to confirm the repeated-notification suppression.

Next, in a case where the notification has not been executed in the same room (location) thereby causing step S4 to be “No”, the controller 21 determines the electronic device with the priority order of “M” as the notification execution device, and causes the determined device to execute the notification in step S5. In a case where step S4 is “Yes”, the controller 21 confirms in step S6 whether there remains an electronic device to which an inquiry about the human detection result can be sent.

In a case where step S6 is “Yes”, the controller 21 performs, in step S7, count-up processing on the variable N, which refers to the order of inquiry, by one, and continues to confirm whether the notification can be executed by the electronic device 10 with the priority order of (“M+1”). In a case where step S6 is “No”, the controller 21 reports the content of the notification data to the mobile terminal 30 in the external network, and then terminates the process (step S10).

The notification device determination process carried out in step S4 to step S6 as described above is continued until the notification is executed by any of the electronic devices (step S5), or the notification data is transmitted to the external mobile terminal 30 (step S10).

After executing the notification (step S5), the controller 21 performs the same corresponding operation confirmation decision process as that in the first embodiment in steps S8 and S9.

In a case where step S8 is “Yes”, the controller 21 completes all of the corresponding operation confirmation decision process and the notification process, and then terminates the notification control (end). In a case where step S8 is “No”, the controller 21 confirms in step S9 whether a prescribed time has passed since the execution of the notification (step S5). A time of approximately 1 to 10 minutes, for example, is set as the prescribed time.

In a case where step S9 is “No”, the controller 21 returns to step S8 to continue the confirmation of the presence or absence of the corresponding operation by the user. When the corresponding operation is confirmed (“Yes” in step S8), the corresponding operation confirmation decision process is terminated (end).

In a case where step S9 is “Yes”, the controller 21 returns to step S7 of the notification execution device determination process, and after adding one to the variable M, which refers to the priority order of notification execution, the controller 21 again iterates the repeated-notification suppression confirmation process (step S4) and the confirmation of whether there remains an electronic device capable of notification (step S6) until no confirmation target device capable of notification is present.

As described above, the notification control system 100 of the second embodiment is able to minimize a situation in which notifications having the same content are successively executed a plurality of times in the same room. Moreover, the notification control system 100 is able to directly report, to the user, the notification data issued by one of the electronic devices 10, which is a notification request source, by notification from a notification execution device installed in a remote room.

In the notification control system 100 of the second embodiment, when the notification data is data related to abnormalities, malfunctions, or the like of an electronic device, the controller 21 causes all of the electronic devices 10 capable of executing notification to execute the notification at any time or at a pattern time described in any of the examples.

### Third Embodiment

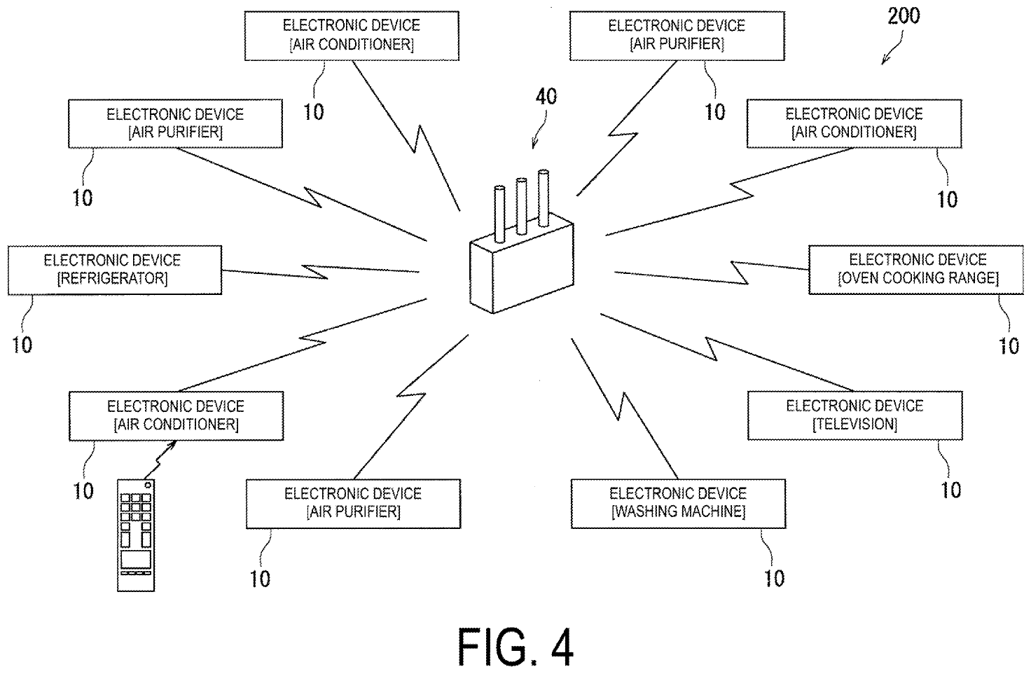

Next, control of a notification control system 200 of a third embodiment will be described with reference to FIGS. 4 to 6 and Table 5. FIG. 4 is a diagram illustrating the notification control system 200 according to the present embodiment. FIG. 4 also illustrates, like FIG. 1, a home network configured by a plurality of electronic devices 10, such as smart home appliances.

As illustrated in FIG. 4, the notification control system 200 includes the plurality of electronic devices 10 connectable to a home network in a home (house), and a wireless LAN router 40 configured to provide mutual communication among these devices.

As in the second embodiment, each of the electronic devices 10 is an electronic device primarily used within a house for household use (a so-called home appliance or consumer electronics product), and is a consumer electronics product called an IoT home appliance or a smart home appliance equipped with a network communication function. In FIG. 4, representative domestic electronic devices 10 are described as examples, and additionally the notification control system 200 may include various IoT home appliances or smart home appliances.

The notification control system 200 illustrated in FIG. 4 differs from the notification control system 100 of the first and second embodiments most in that it does not include a management server on a cloud (the Internet) and that the notification control is performed within an intranet in the house.

Due to this, one device among the plurality of electronic devices 10 included in the notification control system 200 comprehensively controls the entire notification control system 200 as a notification control device 10A configured to manage a notification process in which, for example, the electronic device 10 (notification execution device) for executing a notification is determined, as is performed by the server 20 in the first embodiment.

The notification control device 10A is an example of a notification control device in the present disclosure. Among the electronic devices 10, a representative electronic device configured to control the notification process of the entire notification control system 200 as a notification control device is referred to as an “electronic device 10A”, and devices other than this device are each referred to as an “electronic device 10B”. Differences in configuration between the electronic devices 10A and 10B are the notification data acquisition unit 1a and a human detection result acquisition unit 1b in a controller 1, and a notification management table 2a in a storage unit 2. Accordingly, between the electronic device 10A and the same type of electronic device, a difference in apparent shape and any other differences in basic functions are not present.

In the notification control system 200 in FIG. 4, the connection between each of the electronic devices 10 and the wireless LAN router 40 may be a wireless or wired connection, or a combination thereof. The wireless LAN router 40 is a commercially available general purpose router, and therefore is not particularly described herein. Each of the electronic devices 10 is able to connect to the Internet via the wireless LAN router 40.

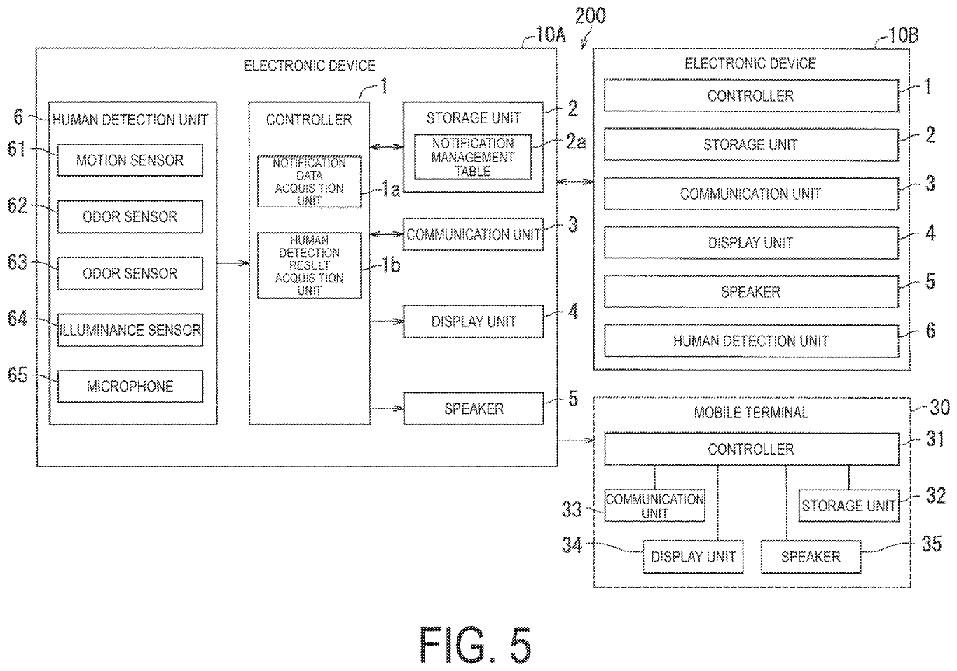

Next, a configuration of the notification control system 200 will be described with reference to FIG. 5. FIG. 5 is a block diagram illustrating the configuration of the notification control system. 200 of the present embodiment.

For the electronic devices 10 (including 10A and 10B), functional features specific to the domestic electronic devices 10 such as a refrigeration and freezing function, a cooking function, a household function, and an air-conditioning function are not described, and only configurations related to notification control will be described.

As illustrated in FIG. 5, the electronic devices 10A and 10B each include the controller 1, the storage unit 2, the communication unit 3, the display unit 4, the speaker 5, and the human detection unit 6. The display unit 4 and the speaker 5 are both examples of a notification unit configured to notify the user of information.

The difference in configuration between the electronic device 10A and the electronic device 10B is such that the electronic device 10A includes the notification data acquisition unit 1a configured to acquire notification data related to the other electronic devices, the human detection result acquisition unit 1b configured to acquire a human detection result related to the presence or absence of a person in a prescribed region, and the notification management table 2a configured to store the electronic devices capable of executing a notification.

A detailed configuration of the electronic device 10A will be described below. Portions of the configuration that are the same as the configuration of the electronic device 10 described in the first and second embodiments will be described briefly.

The controller 1 includes a processor to control each unit of the electronic device 10A based on a program or the like stored in the storage unit 2.

The controller 1 includes the notification data acquisition unit 1a and the human detection result acquisition unit 1b described in the first and second embodiments. The notification data acquisition unit 1a acquires notification data issued by any of the electronic devices 10. The human detection result acquisition unit 1b acquires both a human detection result detected by the human detection unit 6 of the electronic device 10A as the own device, and a human detection result in a prescribed region (for example, in a room) detected by the human detection unit 6 of the electronic devices 10B as other devices.

The controller 1 causes the storage unit 2 to store operation data regarding the electronic device 10B, identification information for identifying each electronic device 10B, and the like transmitted from the controller of the electronic device 10B.

The storage unit 2 includes a storage device such as a semiconductor memory and/or a hard disk drive. The storage unit 2 stores a control program used for controlling operations of each unit of the electronic device. The control program stored in the storage unit 2 is executed by the controller 1.

The storage unit 2 stores the human detection results acquired from each of the electronic devices 10B. Specifically, the controller 1 associates the human detection results detected by the human detection unit 6 of each of the electronic devices 10B, which are acquired by the human detection result acquisition unit 1b, with the identification information for identifying each electronic device 10B, and registers these human detection results in the notification management table 2a.

Further, the storage unit 2 may register, as human detection results, a detection start time, a detection end time, or a detection integration time in a state of being association with the identification information of each electronic device 10B in the notification management table 2a.

The communication unit 3 exchanges data or signals with each of the electronic devices 10B via the wireless LAN router 40. The communication unit 3 receives, via the network, the notification data and the human detection results generated in each of the electronic devices 10B. In a case where a notification execution device (one of the electronic devices 10B) for execution the notification is determined, the communication unit 3 transmits the notification data to the notification execution device.

The display unit 4 and the speaker 5 of the electronic device 10A are used when the electronic device 10A (own device) executes the notification. The method for notification may use the sound of the speaker 5, or may combine the sound of the speaker 5 or an alarm sound with display on the display unit 4.

The human detection unit. 6 detects the presence/absence of the user (indoor information) in a specific room in the house (indoors), similarly to the first embodiment.

As illustrated in FIG. 5, the human detection unit 6 of the electronic device 10A may include the motion sensor 61, the odor sensor 62, the dust sensor 63, the illuminance sensor 64, and the microphone 65.

In FIG. 5, sensors and the microphone mounted on an air purifier are exemplified. The electronic device 10B and the IoT home appliance or smart home appliance connected to the in-home network may include all the sensors and the microphone, or may include some thereof. The electronic device 10A includes at least the motion sensor 61.

The electronic device 10E differs from the electronic device 10A in that it includes none of the notification data acquisition unit 1a, the human detection result acquisition unit 1b, and the notification management table 2a.

Note that all of the electronic devices 10 included in the notification control system 200 may include the notification data acquisition unit 1a and both the human detection result acquisition unit 1b and the notification management table 2a. That is, it is possible for any of the electronic devices 10B to serve as a notification control device (electronic device 10A). However, a plurality of notification control devices are not allowed to be present in the home network system, and only one notification control device is allowed to be present at the same time.

Next, notification control of the notification control system 200 of the third embodiment will be specifically described with reference to the flowchart in FIG. 5 and priority lists in “Table 1” and “Table 5”.

In the following, similarly to Specific Example 1, the notification control will be described by exemplifying a case in which a notification is issued indicating that a washing process is finished in the morning time period (6:00-15:00) by a washing machine (device number 009) installed in a washroom (room number 04).

In the third embodiment, a humidifying air purifier (device number 003) is selected as the notification control device (electronic device 10A), focusing on a point that operation rates of air-conditioning devices such as air conditioners and air purifiers are always high in a house. The own device (humidifying air purifier) may be selected as a notification execution device.

As basic information for determining the priority order of notification execution, for example, the notification management table 22a illustrated in Table is registered in the storage unit 2 of the humidifying air purifier (device number 003) to serve as the notification control device.

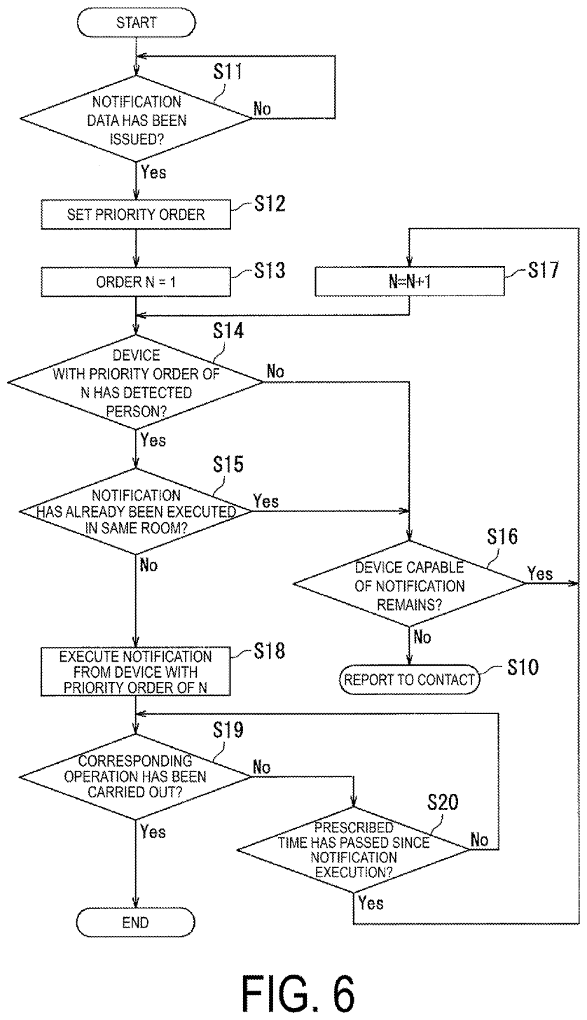

As illustrated in the flowchart of FIG. 6, when the notification control (notification process) is started, first in step 11, the controller 1 of the electronic device 10A (humidifying air purifier) performs notification issue confirmation in which it is confirmed whether notification data issued by any of the electronic devices 10B is contained in the data received by the communication unit 3 via the wireless LAN router 40, that is, it is confirmed whether any of the electronic devices 10B has issued notification data.

In step S11, in a case where the result of the notification issue confirmation is “No”, that rs, no notification data from the other devices has been issued from any of the electronic devices 10E, the controller 1 repeats the notification issue confirmation in step S11 until any of the electronic devices 105 issues notification data.

In a case where one of the electronic devices (a notification request device; the washing machine in this case) has issued notification data and the notification data acquisition unit 1a has acquired the notification data (the determination in step S11 is “Yes”), the controller 1 executes a notification execution device determination process (step S12 to step S17) in which, from among the electronic devices registered in the notification management table 2a and capable of executing notification, the electronic device for executing the notification (notification execution device) is determined based on the human detection results for each of the electronic devices 105 acquired by the human detection result acquisition unit 1b.

The notification execution device determination process will be described below with reference to FIG. 6 and “Table 5”. First, the controller 1 creates a list “Table 5”, which indicates the “order of the electronic devices highly likely to execute the notification”, based on the results of “human detection” having been inquired of each of the electronic devices 105 based on the notification management table 2a (Table 1).

TABLE 5

| Device | | Home appliance | Installation | Room | Priority order | Power | Person |
|---|---|---|---|---|---|---|---|
| No. | Product name | group | location | No. | 6:00-15:00 | supply | detected? |
| 009 | Washing machine | Everyday-life | Washroom | 04 | Notification | ON | No |
| | | home appliance | | | source | | |
| 004 | Air | Air-conditioning | Dining room | 02 | 1 | OFF | (Start) |
| | conditioner B | home appliance | | | | | |
| 005 | Air purifier A | Air-conditioning | Dining room | 02 | 2 | OFF | — |
| | | home appliance | | | | | |
| 006 | Refrigerator | Kitchen home | Kitchen | 03 | 3 | Always | Yes/No |
| | | appliance | | | | ON | |
| 007 | Rice cooker | Kitchen home | Kitchen | 03 | 4 | OFF | — |
| | | appliance | | | | | |
| 008 | Oven cooking | Kitchen home | Kitchen | 03 | 5 | OFF | — |
| | range | appliance | | | | | |
| 001 | Television A | AV home appliance | Living area | 01 | 6 | OFF | — |
| 002 | Air | Air-conditioning | Living area | 01 | 7 | ON | Yes/No |
| | conditioner A | home appliance | | | | | |
| 003 | Humidifying air | Air-conditioning | Living area | 01 | (Notification | Always | Yes/No |
| | purifier | home appliance | | | control) | ON | |
| 010 | Television B | AV home appliance | Living room | 05 | 9 | OFF | — |
| | | | A | | | | |
| 011 | Air | Air-conditioning | Living room | 05 | 10 | OFF | — |
| | conditioner C | home appliance | A | | | | |
| 012 | Air purifier B | Air-conditioning | Living room | 05 | 11 | Always | Yes/No |
| | | home appliance | A | | | ON | |
| 013 | Air | Air-conditioning | Living room | 06 | 12 | OFF | — |
| | conditioner D | home appliance | B | | | | |
| 014 | Air purifier C | Air-conditioning | Living room | 06 | 13 | Always | Yes/No |
| | | home appliance | B | | | ON | |
| 015 | Air | Air-conditioning | Living room | 07 | 14 | OFF | — |
| | conditioner E | home appliance | C | | | | |
| 016 | Air purifier D | Air-conditioning | Living room | 07 | 15 | OFF | — |
| | | home appliance | C | | | | |
| 019 | Vacuum cleaner | Everyday-life | Closet/ | 09 | 16 | OFF | — |
| | | home appliance | corridor | | | | |
| 020 | Dehumidifying air | Air-conditioning | Closet/ | 09 | 17 | Always | (End) |
| | purifier | home appliance | corridor | | | ON | |
| 017 | Air | Air-conditioning | Children's | 08 | Excluded | OFF | — |
| | conditioner F | home appliance | room A | | | | |
| 018 | Air purifier E | Air-conditioning | Children's | 08 | Excluded | ON | — |
| | | home appliance | room A | | | | |
| [symbol] [symbol] | [symbol] [symbol] [symbol] [symbol] [symbol] | [symbol] [symbol] [symbol] | [symbol] [symbol] [symbol] [symbol] | [symbol] [symbol] | [symbol] [symbol] | [symbol] [symbol] | [symbol] [symbol] |

A specific control method will be described. The list of “priority order” illustrated in “Table 5” is, similarly to Table 2, Table 3, and Table 4, a list based on the priority order in “Table 1”. However, the list of Table 5 is different from the lists indicating the “notification execution priority order” such as those of Table 2, Table 3 and Table 4, and is a list of “priority order of result inquiry” indicating the order of inquiring the presence/absence of human detection results.

Accordingly, when the “priority order of result inquiry” list (Table 5) is set in step S12, the controller sequentially inquires of the electronic devices 10B whether each electronic device 10B is capable of executing a notification in step S13 and steps S14 to S17 in accordance with the priority order. That is, at the time of inquiry, the controller 1 is able to execute the notification from the electronic device 10B, in the surrounding of which a person is surely present.

The notification execution device determination process (steps S12 to S17) will be described with reference to the flow in FIG. 6.

After creating the “priority order of result inquiry” list (Table 5) in step S12, the controller 1 sequentially inquires of each electronic device 10B whether that device capable of notification along the list.

First, in step S13, a value of “1” (first) is substituted into a variable N, which indicates the order of inquiry. Then, in step S14, the controller 1 acquires a human detection result indicating whether the electronic device 10B with the priority order of “N (N-th)” has detected a person at the current time (inquiry time).

Note that “Table 5” indicates the priority order of inquiry. For example, the order of inquiry starts from a high-ranked “air conditioner” (device number “004”) and ends at a “dehumidifying air purifier” (device number 020) in the “human detection” column of Table 5.

The electronic device unable to obtain a human detection result due to its power supply being turned off is displayed with “OFF” in Table 5.

In step S14, in a case where the inquiry target device has detected a person (“Yes” in step S14), the controller 1 executes, in step S15, a repeated-notification suppression confirmation process in which, in order to suppress the notification being repeated in the same room, it is confirmed whether the notification has already been execution in the same room (location) as the room where the electronic device 10B with the priority order set to the order of N is disposed.

The repeated-notification suppression confirmation process may be carried out by confirming, for example, whether there is a record indicating that the notification has already been executed by the electronic device having the same room number on the priority order list. Alternatively, in a case where, for example, the electronic device 10B including the microphone 65 recognizes or records the sound of the notification in the same room, the recording may be used to confirm the repeated-notification suppression.

In step S15, in a case where it is confirmed that no notification has been executed yet in the same room (location) (“No” in step S15), the controller 1 determines the electronic device with the inquiry priority order of “N” (N-th) as the notification execution device, and causes the determined device to execute the notification in step S18.

On the other hand, in a case where it is confirmed in step S15 that the notification has already been executed in the same room (location) (“Yes” in step S15) or the human detection result was not obtained in step S14 (“No” in step S14), the controller 1 confirms in step S16 whether there remains an electronic device to which an inquiry about the human detection result can be sent, that is, confirms whether the repeat of notification is confirmed until the last electronic device capable of notification is taken into consideration in the “priority order of result inquiry” list (Table 5).

In step S16, in a case where an electronic device capable of executing the notification still remains (“Yes” in step S16), the controller 1, in step S17, adds one to the variable N, which refers to the order of inquiry. That is, hereinafter, the confirmation of whether the notification can be executed is continued with respect to the electronic device 10B with the priority order of “N+1”.

On the other hand, in step S16, in a case where no electronic device capable of executing the notification remains (“No” in step S16), the controller 1, in step S10, reports the content of the notification data to the mobile terminal 30 in an external network, such as a smart phone for which contact information such as an email address has been registered in advance, and then terminates the process.

The notification device determination process carried out in step S12 to step S17 as described above is continued until the notification is executed, as step S18, by any of the electronic devices, or the notification data is transmitted, as step S10, to the external mobile terminal 30.

Next, when the notification execution device determination process (steps S12 to S17) is complete and the notification is executed in step S18, the controller 1 performs a corresponding operation confirmation decision process in steps S19 and S20 of the flowchart for confirming whether a “corresponding operation,” which is an operation corresponding to the notification by the user, has been carried out.

In the corresponding operation confirmation decision process, first in step S19, it is confirmed whether the corresponding operation has been carried out by the user on the electronic device (in this case, the washing machine) that issued the notification.

In step S19, when the corresponding operation, such as opening or closing the lid of the washing machine, has been carried out (“Yes” in step 319), the controller 1 completes all of the corresponding operation confirmation decision process and the notification process, and then terminates the notification control (end).

In step S19, when the corresponding operation by the user is not confirmed (“No” in step S19), the controller 1 confirms in step S20 whether a prescribed time has passed since the execution of the notification (step S18).

The confirmation of whether the prescribed time has passed since the execution of the notification in step 320 is performed in order to make sure whether the notification was definitely transmitted to the user and thereafter the user has taken appropriate action. For this reason, a time of approximately 1 to 10 minutes, for example, is set as the prescribed time.

In the corresponding operation confirmation decision process from step S19 to step S20, in a case where the length of a state in which no corresponding operation is carried out by the user is less than the prescribed time when measured from the execution of the notification (step S18) (“No” in step S20), the controller 1 returns to step S19 to continue the confirmation of the presence or absence of the corresponding operation by the user. When the corresponding operation is confirmed (“Yes” in step S19), the corresponding operation confirmation decision process is terminated (end).

Further, in step S20, in a case where the length of the state in which no corresponding operation is carried out by the user is equal to or longer than the prescribed time when measured from the execution of the notification, (“Yes” in step S20), the controller 1 returns to step S17 of the notification execution device determination process, and adds one to the variable N, which refers to the priority order of inquiry.

Then, the controller 1, again, following the priority order in sequence, iterates the repeated-notification suppression confirmation process (step S15) and the confirmation of whether there remains an electronic device capable of notification (step S16) until no confirmation target device capable of notification present.

According to the notification control device (10A) and the notification control system 200 of the third embodiment described above, notification data generated by any of the electronic devices 10B connected to the network in the house can be reported from another electronic device 10 (10B or 10A) located closest to the user.

A computer such as a personal computer configured to manage the overall network may be installed in a home, and the server function (function of the electronic device 10A) may be replaced with this computer.

A smart speaker to perform the server function may be disposed in the home network. The smart speaker may function as a notification controller of the notification control system that manages the overall in-home network and notification data in place of the notification control device (electronic device 10A). In addition, the smart speaker may perform human detection, notification execution, or the like, as one of the electronic devices 10 included in the notification control system.

The embodiments of the disclosure have been described with reference to FIGS. 1 to 6 and Tables 1 to 5. However, the disclosure is not limited to the embodiments described above, and may be implemented in various aspects without departing from the gist thereof.

Some constituent elements may be removed from the overall constituent elements indicated in the embodiments. In order to facilitate understanding of the drawings, respective constituent elements are mainly depicted in the drawings schematically, and the number of illustrated constituent elements or the like may be different from the actual number for the sake of convenience when creating the drawings. Each of the constituent elements illustrated in the above embodiments is exemplary and is not particularly limited, and various modifications thereof are possible to be made within a range that does not substantially depart from the effects of the disclosure.

In the notification control systems 100 and 200, the priority order of notification may be changed depending on the content of the notification data. For example, with respect to less urgent notifications such as finish of washing, finish of cooking, water shortage in a humidification water tank of a humidifier, full water in a water storage tank of a dehumidifier, and the like, the priority order may be set initially, from the electronic device 10 installed at a location close to the electronic device for the notification. Conversely, in a case of an urgent notification, the notification may be executed by all of the electronic devices 10 connected to the network regardless of the priority order.

The prescribed condition in the notification control system of the disclosure may be a condition other than the “human detection result” described in the embodiments. For example, the notification execution device may be determined based on a preset priority order. The prescribed condition may be a combination of human detection results and a preset priority order, or a combination of two or more of other conditions.

### INDUSTRIAL APPLICABILITY

The disclosure can be used in the field of notification control devices, notification control systems, notification control methods, and notification control programs.

While preferred embodiments of the present invention have been described above, it is to be understood that variations and modifications will be apparent to those skilled in the art without departing from the scope and spirit of the present invention. The scope of the present invention, therefore, is to be determined solely, by the following claims.

1. A notification control device comprising:
a controller configured to determine a notification execution device for executing a notification; and
a storage unit configured to store a plurality of electronic devices capable of executing the notification,
wherein the controller includes a notification data acquisition unit configured to acquire notification data related to the notification, and
in a case where the notification data acquisition unit acquires the notification data, the controller determines the notification execution device from among the plurality of electronic devices stored in the storage unit based on a prescribed condition.

2. The notification control device according to claim 1,
wherein the controller further includes a human detection result acquisition unit configured to acquire a human detection result in a prescribed region, and
the prescribed condition includes the human detection result acquired by the human detection result acquisition unit.

3. The notification control device according to claim 1, further comprising:
a notification unit configured to execute notification based on the notification data,
wherein the plurality of electronic devices capable of executing the notification include an own device and an other device other than the own device, and
in a case where the own device is determined to be the notification execution device by the controller, the controller causes the notification unit to execute the notification.

4. The notification control device according to claim 1, further comprising:
a communication unit configured to transmit the notification data,
wherein the plurality of electronic devices capable of executing the notification include the own device and the other device other than the own device, and
in a case where the other device is determined to be the notification execution device by the controller, the controller controls the communication unit to transmit the notification data to the other device.

5. The notification control device according to claim 1,
wherein, in a case where a plurality of electronic devices capable of executing the notification are provided, the storage unit stores a priority order of notification execution associated with each of the plurality of electronic devices.

6. The notification control device according to claim 1,
wherein, after a prescribed time has passed since execution of the notification, the controller performs a corresponding operation confirmation decision in which it is confirmed whether a corresponding operation, which is an operation corresponding to the notification data, has been carried out one of the plurality of electronic devices being a transmission source of the notification data acquired by the notification data acquisition unit.

7. The notification control device according to claim 6,
wherein, in a case where a plurality of electronic devices capable of executing the notification are provided, the storage unit stores a priority order of notification execution associated with each of the plurality of electronic devices, and
in a case where, in the corresponding operation confirmation decision, it is determined that the corresponding operation has not been carried out, the controller causes one of the plurality of electronic devices with the priority order lower than the priority order of one of the plurality of electronic devices having executed the notification to execute the notification.

8. The notification control device according to claim 1,
wherein, in a case where the notification data is data related to an abnormality of an electronic device, the controller causes all of the plurality of electronic devices capable of executing the notification to execute the notification.

9. A notification control system comprising:
a controller configured to determine a notification execution device for executing a notification; and
a storage unit configured to store a plurality of electronic devices capable of executing the notification,
wherein the controller includes a notification data acquisition unit configured to acquire notification data related to the notification, and
the controller determines, in a case where the notification data acquisition unit acquires the notification data, the notification execution device from among the plurality of electronic devices stored in the storage unit based on a prescribed condition, and causes the determined notification execution device to execute the notification based on the notification data.

10. A notification control method comprising:
a notification data acquisition step in which a notification data acquisition unit acquires notification data related to a notification; and
a notification execution device determination step in which a controller determines, based on a prescribed condition, a notification execution device configured to execute the notification from among a plurality of electronic devices stored in a storage unit.
